(19) United States
(12) Patent Application Publication
(10) Pub. No.: US 2011/0085170 A1
(43) Pub. Date: Apr. 14, 2011

(54) RESONANCE FREQUENCY-MODULATED SURFACE PLASMA RESONANCE DETECTOR

(76) Inventors: Ta-Jen YEN, Hsinchu County (TW); Chung-Tien LI, Tainan County (TW)

(21) Appl. No.: 12/574,945

(22) Filed: Oct. 7, 2009

(51) Int. Cl. G02B 27/28; G01N 21/55

(52) U.S. Cl. 356/445; 977/920; 977/953

(57) ABSTRACT

A platform able to vary a plasma resonance frequency applies to a prism of a conventional surface plasma resonance system and comprises at least one platform and a plurality of metal lines. The platform is a plate-like structure having two faces—a detection face and a connection face. The metal lines are arranged on the detection face. Each metal line has a width of 20-500nm and a thickness of 20-100nm. The spacing between two adjacent metal lines is 50-1000nm. The prism of the conventional surface plasma resonance technology is an application of the refraction technology. The optical grating technology is another application of the diffraction technology. However, the present invention is different from the abovementioned two technologies. The present invention increases the wavelength range of the absorption spectrum to the mid-infrared ray to promote the detection application of the surface plasma resonance technology.

### FIELD OF THE INVENTION

The present invention relates to a surface plasma resonance technology, particularly to a resonance frequency-modulated surface plasma resonance detector.

### BACKGROUND OF THE INVENTION

Surface plasma resonance is a phenomenon that free electrons move collectively on a metal surface. When the inner and outer components of the electric fields on the vertical metal surface are discontinuous, free electrons cluster locally on the metal surface. In an appropriate condition, the parallel components of the electric fields on the metal surface will drive the local charge density distribution to propagate along the metal surface in form of a compressional-dilatational wave. Such a phenomenon is the so-called surface plasma resonance.

The conventional methods to generate plasma resonance include the grating coupler and the prism coupler. Refer to FIG. 1 for a conventional grating coupler. To realize a grating coupler, the surface of a metal is fabricated to have an optical grating structure 1. The incident light 2 is diffracted by the optical grating structure 1, and the horizontal wave component (the transverse wave) of the light is thus enhanced to such an extent that a surface plasma wave is excited. In practical applications, light has to pass through the test object. Therefore, the reaction chamber and the test object should be high transparent materials.

Refer to FIG. 2A and FIG. 2B for a conventional prism coupler, wherein a high permittivity material is used to generate total reflection. When an electromagnetic wave 3 enters a prism 4 made of a dielectric material, total reflection occurs. The electromagnetic wave 3 also hits a metal surface 5, and the metal has a high permittivity. Thus is generated surface plasma on the metal surface 5. Such a method is very suitable for nanobiological detection. The prism coupler includes an Otto configuration (as shown in FIG. 2A) and a Kretschmann-Raether configuration (as shown in FIG. 2B). In the Otto configuration, there is a gap 6 between the prism 4 and the metal surface 5, and the surface plasma wave is generated in the interface between the air and the metal. However, the distance of the gap 6 is hard to control. In the Kretschmann-Raether configuration, a metal film having an appropriate thickness is directly bonded onto or directly fabricated onto the bottom of the prism 4. As the Kretschmann-Raether configuration is easier to fabricate, it is more frequently used.

The surface plasma resonance wave has two polarization modes—the TE polarization mode and the TM polarization mode. In the TE polarization mode, the direction of the electric field is vertical to the XZ plane. In the TM polarization mode, the direction of the magnetic field is vertical to the XZ plane.

However, mathematic calculations or boundary conditions prove that the metal surface plasma quantum wave cannot exist in the TE polarization mode. According to the boundary condition, the electric field in the TE polarization mode has to maintain continuous on the metal surface. Thus, the TE polarization mode is unlikely to generate charge on the metal interface. In other words, a TE-polarized electromagnetic wave can generate neither free electrons nor surface plasma on a metal surface.

When a TM-polarized electromagnetic wave coming from a common medium hits a metal surface, discontinuous electric fields respectively appear in the inner and outer layers of the metal and generate free electrons. The parallel components of the electric fields drive the free electrons to oscillate along the metal surface to generate a longitudinal wave. The oscillation of free electrons is similar to the oscillation of the lattice of a solid crystal. The oscillation of free electrons also has a specified dispersion relationship and resonance frequency.

The metal surface plasma generated by the TM-polarized electromagnetic wave may be classified into the radiant surface plasma and the non-radiant surface plasma. Refer to FIG. 3. A general light dispersion curve of a medium is unlikely to intersect the non-radiant surface plasma curve 7 (appearing in the lower right area of FIG. 3). No matter how the angle or frequency of light varies, the light dispersion curve cannot intersect the non-radiant surface plasma curve 7 but always appears in the left of the non-radiant surface plasma curve 7. Thus, another mechanism is needed to make the incident electromagnetic wave able to achieve the condition of the non-radiant surface plasma. Besides, the radiant surface plasma curve 8 (appearing in the upper left area of FIG. 3) is generally neglected because of the short life cycle thereof.

The application of the non-radiant surface plasma curve 7 can be implemented by the mechanisms of varying the resonance angle, resonance wavelength, intensity and phase of the incident electromagnetic wave. Thereby, the slope of the light and incident electromagnetic wave can be curved to intersect the non-radiant surface plasma curve 7 in the prism coupler. In comparison with the grating coupler, the slope of the light dispersion curve can be displaced to enable an intersection in the grating coupler.

After the long-term practice of the conventional technology, it is found that the more even the refractive surface, the shaper the profile of the absorption spectrum. For the traditional plasma resonance detection technology that is mainly used to detect smaller molecules (such as the antibodies), a finer and shaper spectrum profile generates better results. However, it is pretty hard for the plasma resonance technology to penetrate and detect larger objects (such as cells).

It is found in many experiments that the size of nanoparticles or the arrangement characteristics of a single layer of molecules on a refractive surface is likely to cause the red shift or blue shift of an absorption spectrum. In other words, the shape of nanoparticles influences the position of the absorption peak. Especially, the irregular gold nanoparticles may cause several absorption peaks, which are hard to interpret. The abovementioned phenomenon is problematic and undesirable for a small-molecule (such as an antibody). For a larger or more irregular test object, the phenomenon of the red shift or blue shift may be an opportunity to get a technological breakthrough.

As the prior art cannot penetrate and detect larger biological test objects (such as cells), it is hard to provide more active research requirements or biological tests. Based on the phenomenon found in the application of the plasma resonance technology to detect smaller molecules, the present invention intends to make use of the red shift and blue shift to achieve advanced applications of intersection and plasma resonance.

### SUMMARY OF THE INVENTION

One objective of the present invention is to provide a platform able to vary the plasma resonance frequency for the conventional surface plasma resonance technology.

To achieve the abovementioned objective, the present invention proposes a platform able to vary a plasma resonance frequency, which applies to a prism of a surface plasma resonance system, and which comprises at least one platform and a plurality of metal lines. The platform is a plate-like structure and has two faces: a detection face and a connection face. The metal lines are arranged on the detection face. Each metal line has a width of 20-500 nm and a thickness of 20-100 nm. The spacing between two adjacent metal lines is 50-1000 nm.

The resonance frequency-modulated surface plasma resonance detector of the present invention has the following advantages.

The conventional biological detection technology applies to the couples of biological substances having mutual affinity, such as enzyme and substrate, enzyme and coenzyme, enzyme and inhibitor, antigen and antibody, hormone and receptor, etc., which are all smaller molecules having specificity. The conventional biological detection technology has been very mature, culturing from the strains, cells or tissues and observing microscopically to use RIA (radioimmunoassay) or ELISA (Enzyme-Linked ImmunoSorbent Assay) to research protein specificity. However, the conventional biological detection technology has not yet had sufficient efficiency to obtain results instantly. Besides, some fluorescent or radioactive materials are used in RIA or ELISA, which may cause danger and harm health.

Below is described the principle of the plasma resonance biological detector. An incident light beam transmits to a metal surface and induces electron oscillation. The oscillation is transmitted to the metal atoms inside the metal surface and generates resonance, whereby the concentration variation of the test object on the metal surface can be instantly detected without any pre-processing, such as labeling. In a test, antibodies are usually fixed on the surface of a metal film, and antigens in the sample then combine with the antibodies. Thereby, the tester can grasp in realtime the affinity reaction process where the antibodies combine with or dissociate from the antigens.

It is expected in testing cells or tissues to achieve a greater detection depth. According to optics, the longer the wavelength is, the deeper the light penetrates. However, the principle cannot apply to biological tests because biological tissue contains a great amount of water molecules. Water molecules absorb the infrared ray having a wavelength of 1300-2600 nm. Therefore, infrared ray not only induces the oscillation and absorption of water molecules but also causes the thermal damage of biological tissue. Besides, the melanin of biological tissue absorbs ultraviolet ray and visible ray. Thus, ultraviolet ray and visible ray enter biological tissue, and the scattered light thereof, which is detected to obtain information in test, is reduced. Considering the abovementioned factors, the light source for biological tests usually adopts the near-infrared ray having a wavelength of 740-1500 nm.

The present invention generates an absorption spectrum within the wavelength range of 740-2000 nm, which belongs to a wave band of mid, near-infrared ray. Such a wave band can realize instant detection without thermal damage of biological tissues.

### BRIEF DESCRIPTION OF THE DRAWINGS

FIG. 1 is a diagram schematically showing a grating coupler of the conventional plasma resonance technology;

FIG. 2A is a diagram schematically showing the Otto configuration of the prism coupler of the conventional plasma resonance technology;

FIG. 2B is a diagram schematically showing the Kretschmann-Raether configuration of the prism coupler of the conventional plasma resonance technology;

FIG. 3 is a diagram showing a dispersion relationship of a conventional metal surface plasma;

FIG. 4 is a diagram schematically showing a platform according to the present invention;

FIG. 5 is a diagram schematically showing the operation of the platform according to the present invention;

FIG. 6 is a diagram schematically showing the interaction of electric field, magnetic field and metal lines in a platform according to the present invention; and

FIG. 7 is a diagram showing the absorption spectrums of the platform obtained by the present invention.

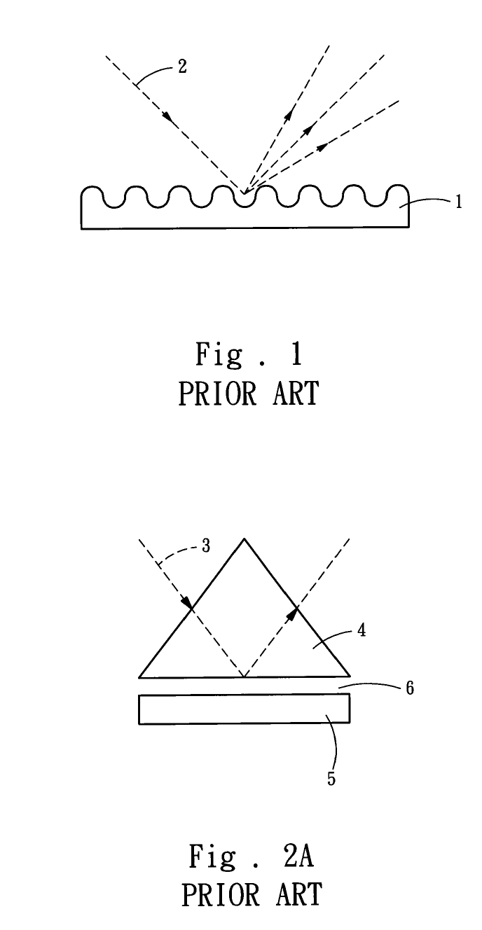

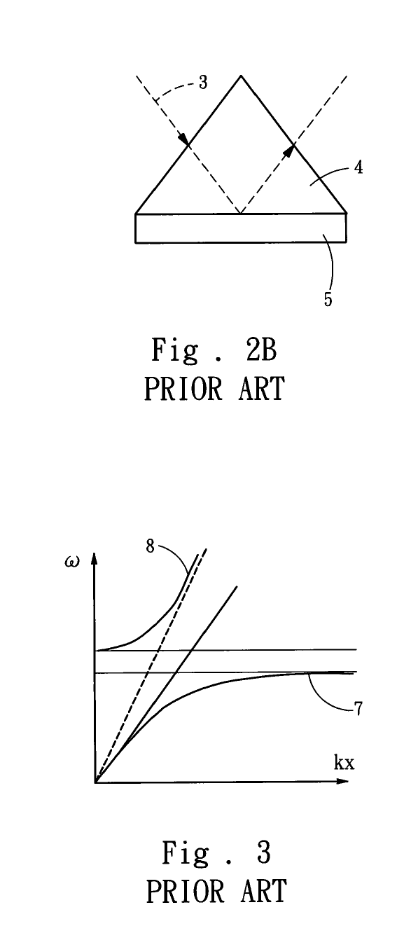

### DETAILED DESCRIPTION OF THE PREFERRED EMBODIMENTS

Below, the technical contents of the present invention are described in detail with the embodiments. However, it should be understood that the embodiments are only to exemplify the present invention but not to limit the scope of the present invention.

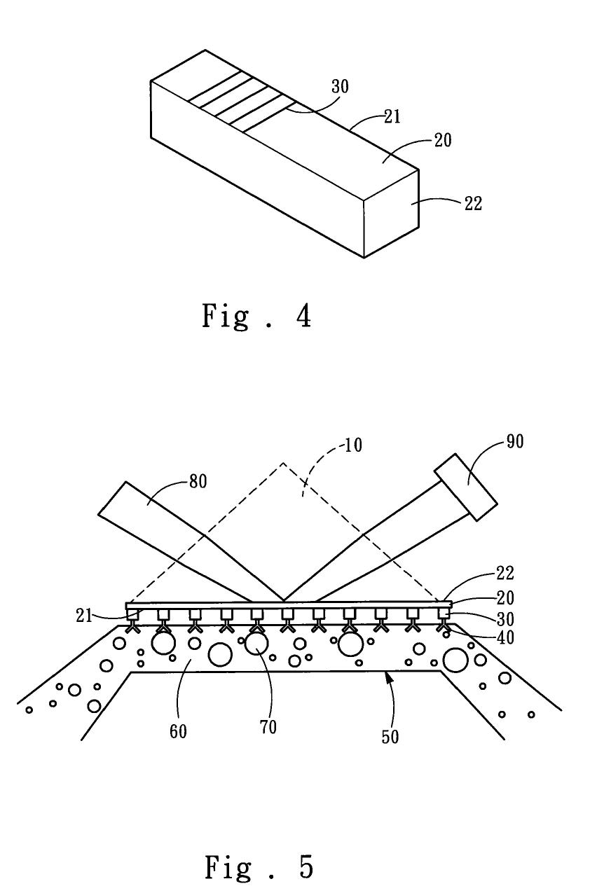

Refer to FIG. 4 and FIG. 5 respectively a diagram schematically showing a platform according to the present invention and a diagram schematically showing the operation of the platform according to the present invention. The platform 20 applies to a prism 10 of a conventional surface plasma resonance system and comprises at least one platform 20 and a plurality of metal lines 30. The platform 20 is a plate-like structure having two faces—a detection face 21 and a connection face 22. The platform 20 is a glass. The connection face 22 of the platform 20 is adhered to the prism 10. The metal lines 30 are arranged on the detection face 21. The metal lines 30 may be made of gold and has a width of 20-500 nm and a thickness of 20-100 nm. The spacing between two adjacent metal lines 30 is 50-1000 nm.

In the operation of the present invention, the metal lines 30 mount a plurality of bonding/modifying elements 40 and contact a channel 50 after the connection face 22 has been joined to the prism 10. When a biological sample 60 passes the channel 50, the bonding/modifying elements 40 combine with a plurality of targeted samples 70 of the biological sample 60. Next, an incident light beam 80 enters the prism 10 and makes the present invention generate plasma resonance. Then, a detector 90 performs detection.

The result of the plasma resonance detection is mainly influenced by two factors: the detection range and the penetration depth. The detection range correlates with the surface detection area. The penetration depth correlates with the distribution of the dielectric layer and has a greater influence. The electric field attenuates dramatically when the light beam 80 arrives at the surface of the platform 20 and goes into the platform 20. Generally, the penetration depth is limited in only several nanometers.

The relationship between the resonance frequency and the penetration depth is expressed by Equation 1:

$${z}_{dielectric} = \frac{c}{ω} \sqrt{( \frac{{ɛ}_{metal}^{′} + {ɛ}_{dielectric}}{{ɛ}_{dielectric}^{2}} )} \qquad Equation 1$$

wherein

ω=2πf,

Z_{dielectric} the penetration depth in the dielectric layer,
f the resonance frequency
c the light speed.

From Equation 1, it is known that the lower the resonance frequency, the greater the penetration depth. The metal lines 30 are exemplified by gold lines in the description. However, the present invention does not limit the metal lines 30 to be gold lines. The metal lines 30 may also be made of silver, aluminum or copper. When the resonance frequency is 500 THz (terahertz, 1012), the penetration depth is 175 nm.

When the plasma resonance technology applies to detections of cells, several microns of penetration depth is required. The lower resonance frequency generated by the conventional plasma resonance system falls in the range of visible area. However, the resonance frequency is impossible for cells to achieve detection in this aspect since the penetration depth is not deep enough.

The surface plasma frequency is a plasma frequency occurring on the surface of a metal. The plasma frequency is an intrinsic oscillation frequency of a metal. Different metals respectively have different plasma frequencies. The relationship of the surface plasma frequency and the resonance frequency is expressed by Equation 2:

ωₛₚ=ωₚ/\sqrt{1+∈_{dielectric}} Equation 2

wherein ∈_{dielectric} is the permittivity of the dielectric layer. When the dielectric layer is the vacuum, ωsp=ωp/√2. When the metal lines are made of gold, the plasma frequency is about 1909 THz, and the surface plasma frequency ωsp is 1350 THz.

In the present invention, the metal lines arranged discretely and periodically are used to modulate the plasma frequency. The periodically-distributed metal lines can dilute the concentration of electrons, whereby the effect and efficiency of electron mass is enhanced. Appropriately selecting the structural parameter, the present invention can make the surface plasma frequency fall in the range of mid-infrared ray. In the embodiment of the present invention, the plasma frequency is in the range of 70 THz. The accompanying wave of the similar material will not penetrate the gold lines unless the frequency reaches 67 THz. It means that the surface plasma frequency will decrease to as low as 67 THz when the metal lines are made of gold.

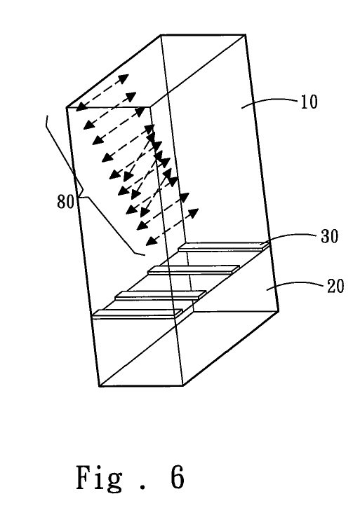

Refer to FIG. 6 a diagram schematically showing the interaction of electric field, magnetic field and metal lines in a platform according to the present invention. An incident light beam 80 hits the metal lines 30. The electric field of the TM polarization light is denoted by double-arrowed lines. The magnetic field of the TM polarization light is denoted by double-arrowed dotted lines. The double-arrowed dotted lines simulating the magnetic field are vertical to the metal lines 30 and only have components on the X-Y plane. The double-arrowed lines simulating the electric field are parallel to the metal lines 30 and only have components on the X-Z plane.

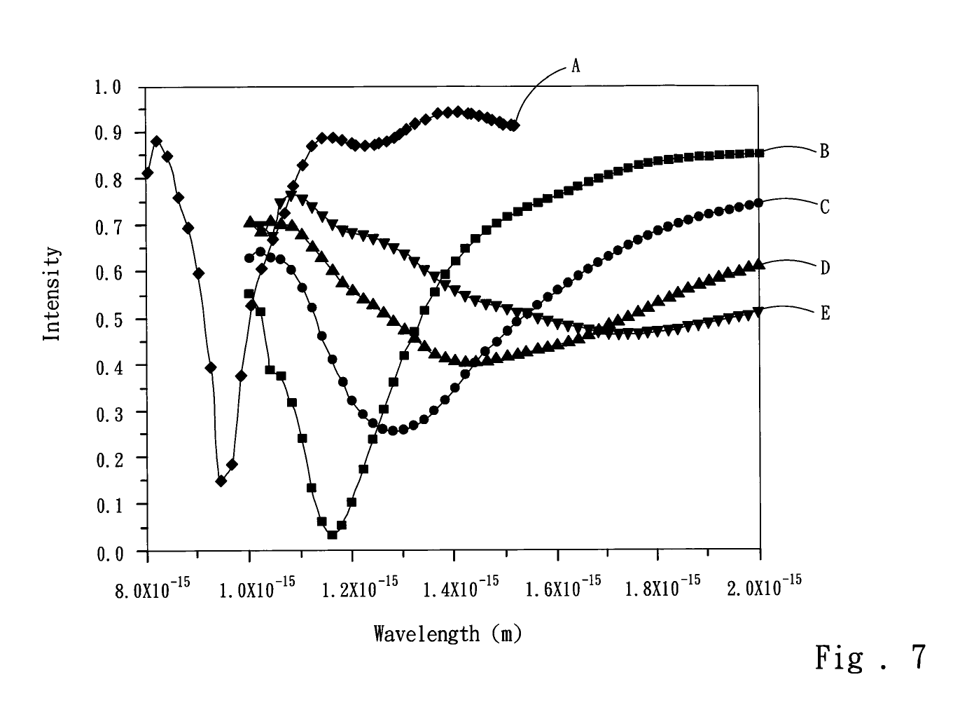

Refer to FIG. 7 a diagram showing the absorption spectrums of the platform obtained by the present invention. Curve A is the absorption spectrum obtained with a platform having a continuous gold film on the surface and has a peak at a wavelength of 950 nm. Curve B is obtained with a platform having metal lines with a spacing of 100 nm and has a peak at a wavelength of 1170 nm. Curve C is obtained with a platform having metal lines with a spacing of 150 nm and has a peak at a wavelength of 1290 nm. Curve D is obtained with a platform having metal lines with a spacing of 200 nm and has a peak at a wavelength of 1420 nm. Curve E is obtained with a platform having metal lines with a spacing of 250 nm and has a peak at a wavelength of 1750 nm.

The visible light having a wavelength over 740 nm belongs to infrared ray. The light having a wavelength of 740-1500 nm belongs to near-infrared ray. The light having a wavelength of 1500-3000 nm belongs to mid-infrared ray. Refer to FIG. 7 again. The peaks of Curve A and Curve B and the entire Curve A and Curve B all fall in the range of near-infrared ray. For Curve C, Curve D and Curve E, the peaks thereof are still in the range of near-infrared ray. However, Curve C, Curve D and Curve E themselves extend out of the range of near-infrared ray and reach the range of mid-infrared ray. Therefore, the detection range of the present invention falls in the range of mid-infrared ray.

The field, which the conventional biological detection technology applies to, includes the couples of biological substances having mutual affinity, such as enzyme and substrate, enzyme and coenzyme, enzyme and inhibitor, antigen and antibody, hormone and receptor, etc., which are all smaller molecules having specificity. The conventional biological detection technology has been very mature, culturing from the strains, cells or tissues and observing microscopically to use RIA (radioimmunoassay) or ELISA (Enzyme-Linked ImmunoSorbent Assay) to research protein specificity. However, the conventional biological detection technology has not yet had sufficient efficiency to obtain results instantly. Besides, some fluorescent or radioactive materials are used in RIA or ELISA, which may cause danger and harm health.

Thus, the present invention is proposed to overcome the conventional problems. When an incident light beam hits a metal surface and induces electron oscillation, the oscillation is transmitted to the metal atoms inside the metal lines and generates plasma resonance. Thereby, the concentration variation of the test object on the metal surface can be instantly detected without any pre-processing, such as labeling. In a test, the bonding/modifying elements, such as antibodies, are fixed on the surface of the metal lines, and antibodies then combine with the targeted samples in the biological sample, such as the antigens. Thereby, the tester can grasp in realtime the affinity reaction process where the antibodies combine with or dissociate from the antigens.

It is expected in testing cells or tissues to achieve a greater detection depth. According to optics, the longer the wavelength is, the deeper the light penetrates. However, the principle cannot apply to biological tests because biological tissue contains a great amount of water molecules. Water molecules absorb the infrared ray having a wavelength of 1300-2600 nm. Therefore, infrared ray not only induces the oscillation of water molecules but also causes the thermal damage of biological tissue. Besides, the melanin of biological tissue absorbs ultraviolet ray and visible ray. Thus, ultraviolet ray and visible ray enter biological tissue, and the scattered light, which is detected by the device to obtain the desired information in test, is reduced. Considering the above-mentioned factors, the light source for biological tests usually adopts the near-infrared ray having a wavelength of 740-1500 nm.

The present invention generates an absorption spectrum within the wavelength range of 740-2000 nm, which belongs to a wave band of mid, near-infrared ray. Such a wave band can realize instant test without thermal damage of biological samples.

What is claimed is:

1. A platform able to vary a plasma resonance frequency, applying to a prism of a surface plasma resonance system, and comprising:
at least one platform being a plate-like structure having a detection face and a connection face; and
a plurality of metal lines arranged on said detection face and each having a width of 20-500 nm and a thickness of 20-100 nm, wherein a spacing between two adjacent said metal lines is 50-1000 nm.

2. The platform able to vary a plasma resonance frequency according to claim 1, wherein said platform is a glass substrate.

3. The platform able to vary a plasma resonance frequency according to claim 1, wherein said connection face of said platform is adhered to said prism.

4. The platform able to vary a plasma resonance frequency according to claim 1, wherein said metal lines are selected from a group consisting of gold, silver, aluminum and copper.

5. The platform able to vary a plasma resonance frequency according to claim 1, wherein a plurality of bonding/modifying elements are arranged on said metal lines.
